(19) United States
(12) Patent Application Publication
(10) Pub. No.: US 2013/0330974 A1
(43) Pub. Date: Dec. 12, 2013

(54) HOMEPLUG

(71) Applicants: SHU-MEI CHEN, NEW TAIPEI CITY (TW); SHIH-PO LO, NEW TAIPEI CITY (TW)

(72) Inventors: SHU-MEI CHEN, NEW TAIPEI CITY (TW); SHIH-PO LO, NEW TAIPEI CITY (TW)

(73) Assignee: ASKEY COMPUTER CORP.

(21) Appl. No.: 13/596,306

(22) Filed: Aug. 28, 2012

(30) Foreign Application Priority Data
Jun. 7, 2012 (TW) 101211006

(51) Int. Cl. H01R 25/00

(52) U.S. Cl. 439/638

(57) ABSTRACT

A HomePlug includes a body, a power socket, and a network port. The body has an installation region, an insertion region, and an operation region defined on a side surface of the body. The power socket is disposed on the insertion region and has a central point. The network port is disposed on the operation region and spaced apart from the central point by a specific distance. Accordingly, not only is the HomePlug convenient to manipulate, but a network cable connected to the HomePlug is also unlikely to bend, even though the HomePlug is installed at an electric outlet positioned proximate to the ground.

### CROSS-REFERENCE TO RELATED APPLICATION

This non-provisional application claims priority under 35 U.S.C. §119(a) on Patent Application No(s).101211006 filed in Taiwan, R.O.C. on Jun. 7, 2012, the entire contents of which are hereby incorporated by reference.

### FIELD OF TECHNOLOGY

The present invention relates to network connection devices, and more particularly, to a HomePlug for use with an indoor power line network.

### BACKGROUND

HomePlugs applies Power Line Communication (PLC) for performing Internet surfing and data transmission, and works in conjunction with a data communication network built from an existing power line framework present in an indoor environment, such as a home, an office, a hospital. Hence, Unlike VDSL/ADSL, Power Line Communication (PLC) does not require constructing an additional circuit network for building a new communication network; instead, Power Line Communication (PLC) allows a user to install a HomePlug directly on an indoor alternating current (AC) electric outlet, such that an electronic device, such as a computer or a cell phone, can be electrically connected to the HomePlug for carrying out data transmission, and enables data communication between the devices thus connected, thereby providing a local area network-based communication framework and allowing the devices to share their accessible resources.

Referring to FIG. 1 and FIG. 2, a conventional HomePlug 100 comprises a power plug 110 and a network port 120, thereby allowing a user to install a power plug (not shown) of the HomePlug 100 on an alternating current (AC) electric outlet 200 inherently installed on an indoor wall and then connect one end of a network cable 300 to the network port 120 and the other end of the network cable 300 to an electronic device (not shown) intended for data transmission. The network port 120 of the conventional HomePlug 100 is usually disposed at the bottom of a side surface thereof As a result, after the HomePlug 100 has been installed at the AC electric outlet 200, the network cable 300 connected to the network port 120 and the electronic device is positioned proximate to the ground in order to avoid laying an indoor wiring within a space in an untidy manner and even posing a threat to user safety.

Referring to FIG. 1 and FIG. 2, the AC electric outlet 200 is usually disposed at the bottom of a wall surface. Take the conventional HomePlug 100 as an example, the network port 120 is disposed at a position 90 mm-130 mm below the power plug 110. After the conventional HomePlug 100 has been installed at the AC electric outlet 200, the space formed between the network port 120 and the ground is small, thereby rendering it difficult for the user to manipulate the network cable 300 during an insertion process thereof Furthermore, the network cable 300 thus inserted is likely to bend when it comes into contact with the ground, thereby bringing inconvenience and limitation to users.

### SUMMARY

It is an objective of the present invention to provide a HomePlug that does not manifest drawbacks of a conventional HomePlug—the conventional HomePlug is installed at an electric outlet positioned proximate to the ground and thus is inconvenient to manipulate, and a connected network cable is likely to bend.

In order to achieve the above and other objectives, the present invention provides a HomePlug, comprising: a body having a surface defined with an installation region, an opposing surface defined with an insertion region, and a side surface defined with an operation region; a power socket disposed on the insertion region and having a central point; and a network port disposed on the operation region and spaced apart from the central point by a specific distance.

The HomePlug further comprises a power plug disposed on the installation region and corresponding in position to the power socket.

As regards the HomePlug, the specific distance ranges between 40 mm and 50 mm, and the operation region is disposed at a position when the HomePlug installed faces the ground.

As regards the HomePlug, the central point is a geometrical center of the power socket.

As regards the HomePlug, the central point is spaced apart from each of a plurality of holes of the power socket by the same distance.

Accordingly, the HomePlug of the present invention is intended to be installed on an indoor AC electric outlet and characterized by a network port positioned proximate to a power socket, so as to enhance ease of use and prevent a network cable connected to the HomePlug from bending.

### BRIEF DESCRIPTION OF THE DRAWINGS

Objectives, features, and advantages of the present invention are hereunder illustrated with specific embodiments in conjunction with the accompanying drawings, in which:

FIG. 1 (PRIOR ART) is a perspective view of a conventional HomePlug;

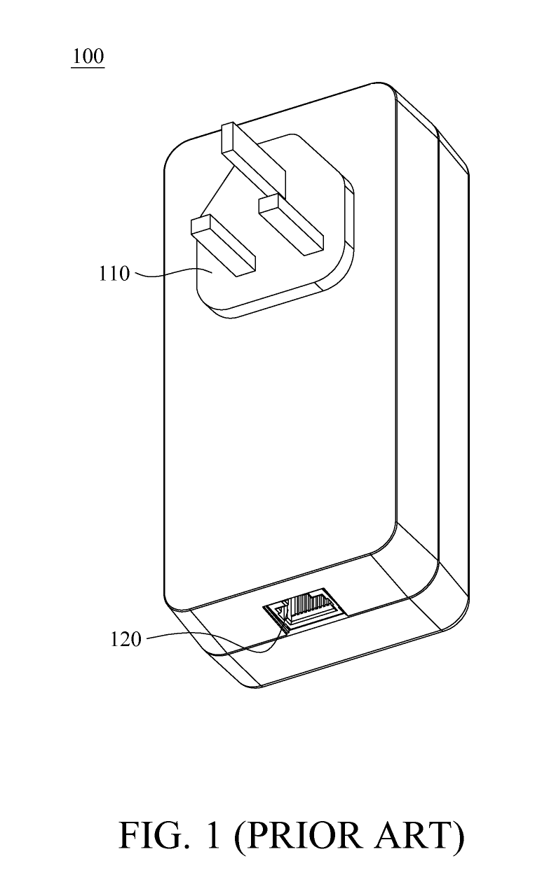

FIG. 2 (PRIOR ART) is a schematic view of the conventional HomePlug installed at an AC electric outlet on an indoor wall surface;

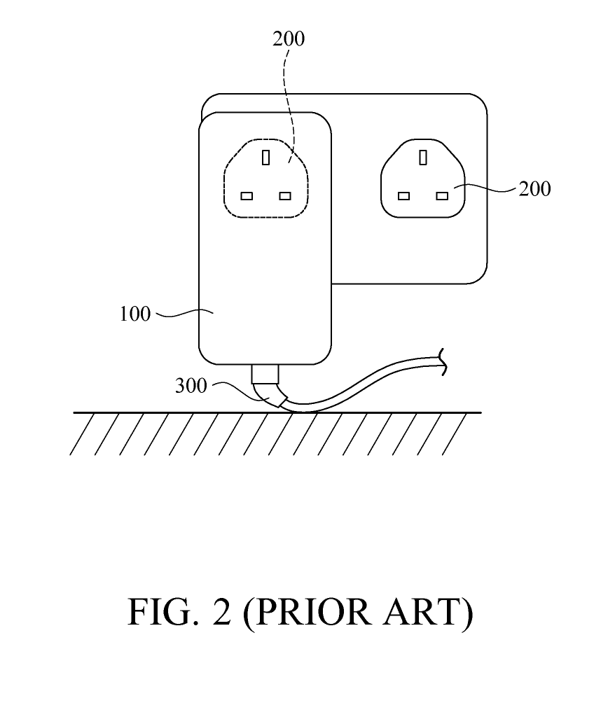

FIG. 3 is a perspective view of a HomePlug according to an embodiment of the present invention; and

FIG. 4 is a schematic view of a central point P and a specific distance D of the HomePlug according to an embodiment of the present invention.

### DETAILED DESCRIPTION

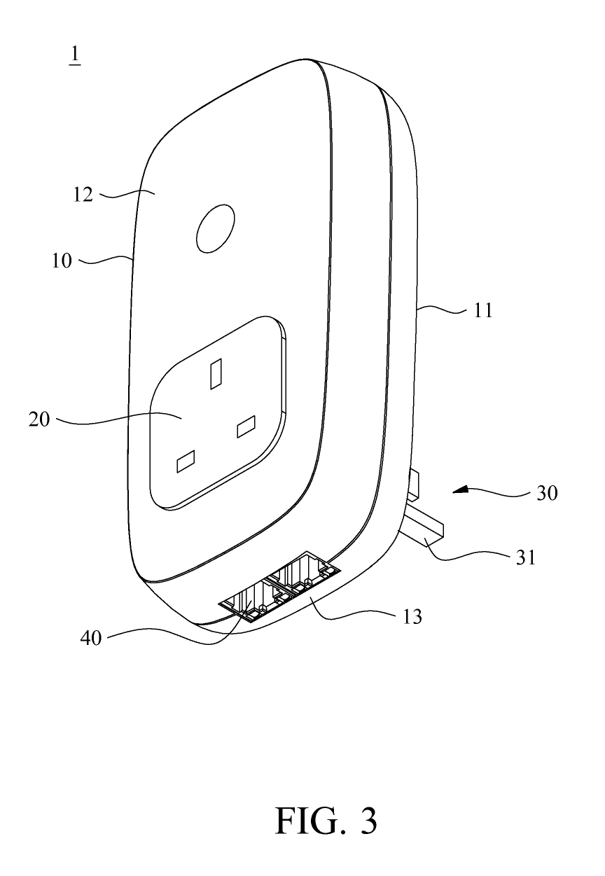

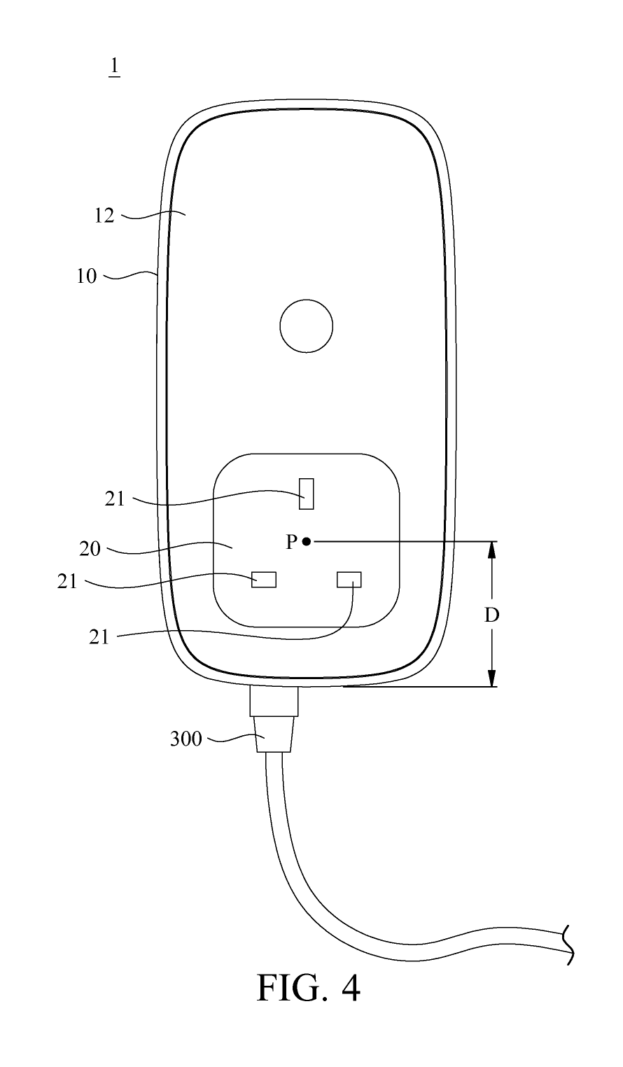

Referring to FIG. 3 and FIG. 4, in an embodiment of the present invention, a HomePlug 1 essentially comprises a body 10, a power socket 20, and a network port 40. An installation region 11 is defined on a surface of the body 10. An insertion region 12 is defined on the opposing surface of the body 10. An operation region 13 is defined on a side surface of the body 10. The power socket 20 is disposed on the insertion region 12 and has a central point P. The network port 40 is disposed on the operation region 13. The network port 40 is spaced apart from the central point P by a specific distance D.

The HomePlug 1 further comprises a power plug 30 disposed on the installation region 11 and corresponding in position to the power socket 20. The power plug 30 enables the HomePlug 1 to be installed on an indoor power line network in order to perform data transmission. Referring to FIG. 4, in this embodiment, the specific distance D ranges between 40 mm and 50 mm. The central point P is the geometrical center of the power socket 20. Alternatively, the central point P can also be defined as being spaced apart from each of a plurality of holes 21 of the power socket 20 by the same distance.

In this embodiment, the body 10 is of a box-like shape, but the present invention is not limited thereto. The body 10 will fulfill the objectives of the present invention, provided that the body 10 is of dimensions that allow the network port 40 to be spaced apart from the central point P by the specific distance D of 40-50 mm. In this embodiment, preferably, the operation region 13 is positioned on a side surface at the bottom of the body 10, such that a network cable 300 connected to the network port 40 is positioned proximate to the ground, so as to be conducive to the neatness of a living environment and facilitate the laying of a substantive wiring. However, this embodiment is illustrative rather than restrictive of the present invention; hence, it is feasible for the operation region 13 to be defined on two sides of the body 10 or a side surface at the top of the body 10, thereby allowing the network port 40 to be disposed on two sides of the body 10 or a side surface at the top of the body 10.

In this embodiment, both the power socket 20 and the power plug 30 meet British Standards. Therefore, the power socket 20 has the holes 21 for insertion by three flat blades of an external plug, whereas the power plug 30 has three flat blades 31; however, the specifications of the power socket 20 and the power plug 30 are not limited thereto. The specifications of the power socket and/or the power plug can also be that of three round pins and holes typical of British Standards, respectively. Alternatively, it is feasible for the power socket and the power plug to meet European Standards, German Standards, Australian Standards, or American Standards. The power plug has two round pins when in compliance with European Standards and German Standards, two non-parallel flat blades when in compliance with Australian Standards, and either two flat blades or two flat blades and a round pin (i.e., the grounding pin) when in compliance with American Standards. Furthermore, it is also feasible that the power socket and the power plug are of different specifications and conform with the internal circuit design of the body so as to further function as a power adapter.

In this embodiment, the network port 40 meets RJ45 standard in order to be inserted by the network cable 300 and connected to an external electronic device, thereby allowing the external electronic device to perform data transmission by means of the HomePlug 1. Furthermore, an interface for use with the network port 40 is not limited to the above-mentioned, but can be one that complies with RJ11 standard.

Accordingly, in an embodiment of the present invention, when a HomePlug is installed at an indoor AC electric outlet, a network port is positioned and spaced apart from the central point of the power socket by a specific distance. Hence, formed between the ground and an operation region which houses the network port is a space large enough to accommodation the connection of a network cable connected to the HomePlug, thereby enhancing ease of use and preventing the network cable from bending.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A HomePlug, comprising:
a body having a surface defined with an installation region, an opposing surface defined with an insertion region, and a side surface defined with an operation region;
a power socket disposed on the insertion region and having a central point; and
a network port disposed on the operation region and spaced apart from the central point by a specific distance.

2. The HomePlug of claim 1, further comprising a power plug disposed on the installation region and corresponding in position to the power socket.

3. The HomePlug of claim 1, wherein the specific distance ranges between 40 mm and 50 mm.

4. The HomePlug of claim 1, wherein the operation region is disposed at a position when the HomePlug installed faces a ground.

5. The HomePlug of claim 1, wherein the central point is a geometrical center of the power socket.

6. The HomePlug of claim 1, wherein the central point is spaced apart from each of a plurality of holes of the power socket by a same distance.
